(19) United States
(12) Patent Application Publication
(10) Pub. No.: US 2024/0155331 A1
(43) Pub. Date: May 9, 2024

(54) SYSTEMS AND METHODS FOR CAPABILITY SIGNALING FOR MAXIMUM SENSITIVITY DEGRADATION PERFORMANCE

(71) Applicant: Meta Platforms Technologies, LLC, Menlo Park, CA (US)

(72) Inventors: Suhwan Lim, Anyang (KR); Yee Sin Chan, San Francisco, CA (US); Ji Woo Kim, San Jose, CA (US)

(73) Assignee: Meta Platforms Technologies, LLC, Menlo Park, CA (US)

(21) Appl. No.: 18/496,423

(22) Filed: Oct. 27, 2023

Related U.S. Application Data
(60) Provisional application No. 63/422,620, filed on Nov. 4, 2022.

(51) Int. Cl. H04W 8/24; H04W 24/02

(52) U.S. Cl. CPC H04W 8/24; H04W 24/02

(57) ABSTRACT

Disclosed herein are aspects related to a device that can include a wireless communication interface and one or more processors. The one or more processors can identify a capability of the device to control a parameter related to receiving a signal via the wireless communications interface. The capability can be representative of an improvement of reception by the device. The one or more processors can provide, to a network device using the wireless communications interface, a signal indicating the capability. The one or more processors can control operation of the wireless communications interface responsive to instructions received from the network device and related to the capability.

### CROSS-REFERENCE TO RELATED APPLICATIONS

The present application claims the benefit of and priority to U.S. Provisional Application No. 63/422,620, filed Nov. 4, 2022, the disclosure of which is incorporated herein by reference in its entirety.

### FIELD OF DISCLOSURE

The present disclosure is generally related to communication for rendering artificial, mixed, virtual, or extended reality, including but not limited to systems and methods for capability signaling for maximum sensitivity degradation performance.

### BACKGROUND

Artificial/extended reality (XR) such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space).

### SUMMARY

Systems that implement XR can transmit data to and receive data from remote devices, such as network base stations, as part of providing XR experiences. Such systems can have communication criteria that correspond to quality of the XR experiences. For example, a device can have one or more criteria for a performance of a receiver of the device in receiving and/or decoding a received signal. The one or more criteria can include a reference sensitivity (REFSENS). Under various conditions, the REF SENS can be relaxed or increased, such as to allow for up to a maximum sensitivity degradation (MSD). However, REF SENS and/or MSD levels may be set in accordance with operation of relatively low performance devices, and can depend on factors such as hardware of the device (e.g., of a receive chain), communication bands to be used, interference, harmonics, or various combinations thereof, such that devices that have capabilities for improved performance may not necessarily be operated in a manner that takes advantage of such capabilities.

Systems and methods in accordance with the present disclosure can identify a capability of a device to control its performance, e.g., control operational factors that affect REF SENS and/or sensitivity exception requirements, such as MSD, and communicate an indication of that capability to a remote device, such as a base station. This can allow the base station to provide scheduling instructions to the device to allow the device to perform transmission (or reception) in a manner to use the capability to perform more effectively under interference or other conditions that might otherwise reduce performance.

Various implementations disclosed herein are related to a device that can include a wireless communication interface and one or more processors. The one or more processors can identify a capability of the device to control a parameter related to receiving a signal via the wireless communications interface. The capability can be representative of an improvement of reception by the device. The one or more processors can provide, to a network device using the wireless communications interface, a signal indicating the capability of the device. The one or more processors can control operation of the wireless communications interface responsive to instructions received from the network device and related to the capability.

In some implementations, the parameter corresponds to at least one of a receiver reference sensitivity of the wireless communications interface or an improved sensitivity degradation level of the wireless communications interface. For example, the improvement represented by the capability and/or the improved sensitivity degradation level can correspond to the ability of the device to use a reduced exception to a reference sensitivity under interference conditions, such as to have a lower amount of MSD as compared with a baseline and/or specification MSD. The capability of the device can relate to controlling a signal to interference and noise ratio of signals received by the wireless communications interface. The one or more processors can generate the signal indicating the capability using a bitmap.

In some implementations, the one or more processors are to apply an enhancement to a sensitivity of the wireless communications interface responsive to the instructions, such as to operate with a reduced sensitivity that is not reduced as much as a baseline reduction. In some implementations, the one or more processors are to monitor a sensitivity degradation related to a signal received by the wireless communications interface and provide the signal indicating the capability responsive to the monitoring. The one or more processors can control operation of one or more antennas of the wireless communications interface responsive to the instructions.

Various implementations disclosed herein relate to a system. The system can include a first device and a second device. The first device can include a wireless communications interface and one or more processors. The one or more processors can identify a capability of the first device to control a parameter related to receiving a signal via the wireless communications interface. The capability can be representative of an improvement of reception by the device. The one or more processors can transmit, using the wireless communications interface, a signal indicating the capability. The second device can provide instructions to the first device to control operation of the first device according to the capability.

In some implementations, the parameter corresponds to at least one of a receiver reference sensitivity of the wireless communications interface or an improved sensitivity degradation level of the wireless communications interface. For example, the improvement represented by the capability and/or the improved sensitivity degradation level can correspond to the ability of the device to use a reduced exception to a reference sensitivity under interference conditions, such as to have a lower amount of MSD as compared with a baseline and/or specification MSD. In some implementations, the capability of the first device relates to controlling a signal to interference and noise ratio of signals received by the wireless communications interface. The first device can be a user equipment (UE), and the second device can be a network base station. In some implementations, the one or more processors are to control operation of one or more antennas of the wireless communications interface according to the instructions.

In some implementations, the one or more processors can apply an enhancement to a sensitivity of the wireless communications interface responsive to receiving the instructions from the second device. In some implementations, the one or more processors can monitor a sensitivity degradation related to a target signal received by the wireless communications interface and provide the signal indicating the capability responsive to the monitoring. In some implementations, the one or more processors can generate the signal indicating the capability using a bitmap.

Various implementations disclosed herein relate to a method. The method can include identifying, by one or more processors of a device, a capability of the device to manage a parameter related to receiving a signal via a wireless communications interface of the device. The capability can be representative of an improvement of reception by the device. The method can include providing, by the one or more processors using the wireless communications interface, to a network device, a signal indicating the capability of the device. The method can include receiving, by the one or more processors subsequent to providing the signal, one or more instructions from the network device relating to the capability. The method can include operating, by the one or more processors, the device according to the instructions.

In some implementations, the parameter corresponds to at least one of a receiver reference sensitivity of the wireless communications interface or an improved sensitivity degradation level of the wireless communications interface. For example, the improvement represented by the capability and/or the improved sensitivity degradation level can correspond to the ability of the device to use a reduced exception to a reference sensitivity under interference conditions, such as to have a lower amount of MSD as compared with a baseline and/or specification MSD. In some implementations, the capability of the device relates to managing a signal to interference and noise ratio of signals received by the wireless communications interface.

In some implementations, the method includes applying an enhancement, by the one or more processors, to a sensitivity of the wireless communications interface responsive to the instructions. In some implementations, the method includes monitoring, by the one or more processors, a sensitivity degradation related to a target signal received by the wireless communications interface. In some implementations, the method includes providing, by the one or more processors, the signal indicating the capability responsive to the monitoring.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of an example wireless communication system, according to an example implementation of the present disclosure.

FIG. 5 is a block diagram of a system for capability signaling for maximum sensitivity degradation performance, according to an example implementation of the present disclosure.

FIG. 6 is a flow chart of a method of capability signaling for maximum sensitivity degradation performance, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Systems and methods in accordance with the present disclosure are related to implementing a communication system that can provide a signal indicating its capability to adjust sensitivity degradation, which can allow for adjustments of operation related to receiver sensitivity. For example, devices (e.g., wireless communication devices) may be expected to meet thresholds or standards related to receiver sensitivity, such as a receiver reference sensitivity indicative of how receiver electronics (e.g., a receiver radio frequency chain) of the device affects signal to noise ratio of received signals, as well as maximum sensitivity degradation (MSD) performance, which indicate an ability of the device to allow for changes in receiver sensitivity to account for interference, such as self-interference. If a carrier aggregation/dual connectivity (CA/DC) device has self-interference, for example, a specified MSD level may apply, where the MSD level can be an offset from a minimum reference sensitivity threshold (e.g., a reference sensitivity threshold that can be associated with LTE/NR CA/DC bands). For example, the MSD level of a device can be used as an exception in a downlink slot or receiver band to allow for receiver sensitivity degradation responsive to interference. Receiver reference sensitivity and/or MSD levels may be defined according to operation of relatively low performance devices.

Systems and methods in accordance with the present disclosure can enable a device to provide a signal indicating a signal degradation parameter indicative of the ability of the device to adjust its reception and/or sensitivity performance while still meeting appropriate performance criteria. For example, a device can provide a signal indicative of capability of MSD level adjustment, such as MSD level improvement. The device can provide the signal based on one or more characteristics or components of the device, such as characteristics indicative of the ability of the device to control at least one of antenna isolation, PCB isolation, or PA attenuation. The device can use a low data usage signal, such as a 3-bit signal (e.g., based on retrieving values for the 3 bits from a bitmap) to indicate the capability. A network device can receive the capability signal and modify communication with the device and/or provide instructions to the device to enable the device to modify communication, such as to control operation of a wireless communications interface using a modified reference sensitivity, responsive to the instructions.

In some implementations, a device includes a wireless communications interface and one or more processors. The one or more processors can provide a degradation capability signal to a network, such as a network device that the wireless communications interface is communication with using a communications link. The one or more processors can provide the degradation capability signal based on identifying one or more characteristics of the device, such as characteristics associated with the ability of the device to performance antenna isolation, PCB isolation, and/or PA attenuation. The one or more processors can generate the degradation capability signal to include a plurality of bits indicating a capability of the device using the plurality of bits. The network device can receive the indication of the capability and can provide instructions for operation of the device responsive to the indication. The device can control operation of the wireless communications interface responsive to the instructions.

Although various implementations disclosed herein are provided with respect to wearable devices, principles disclosed herein can be applied to any other type of devices such as handheld, mobile or small form factor devices (e.g., smart phones, tablet computers, laptops, etc.).

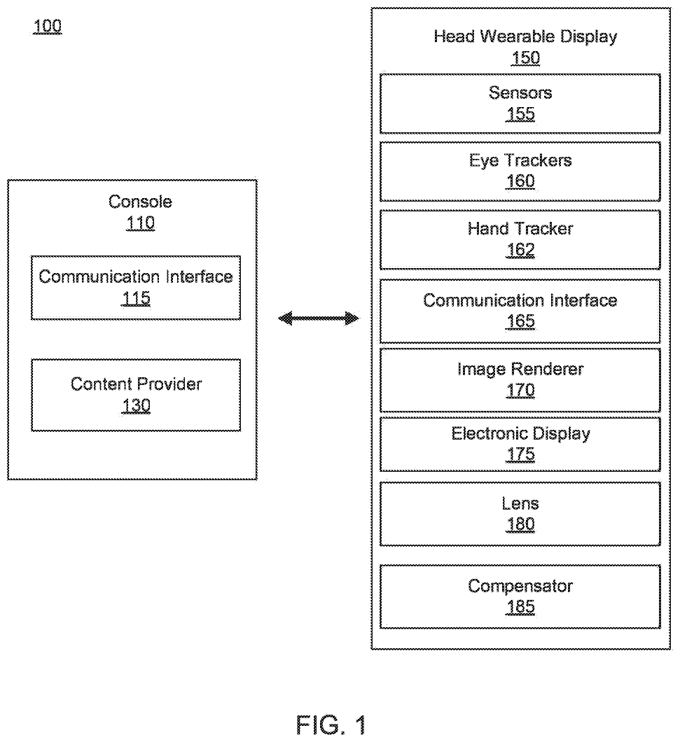

FIG. 1 is a block diagram of an example artificial reality system environment 100. In some implementations, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HMD 150, the detected shape, location and/or orientation of the body/hand/face of the user, and/or a user input for the artificial reality, and transmit the image data to the HWD 150 for presentation. In some implementations, the artificial reality system environment 100 includes more, fewer, or different components than shown in FIG. 1. In some implementations, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some implementations, the console 110 is integrated as part of the HWD 150.

In some implementations, the HWD 150 is an electronic component that can be worn by a user and can present or provide an artificial reality experience to the user. The HWD 150 may render one or more images, video, audio, or some combination thereof to provide the artificial reality experience to the user. In some implementations, audio is presented via an external device (e.g., speakers and/or headphones) that receives audio information from the HWD 150, the console 110, or both, and presents audio based on the audio information. In some implementations, the HWD 150 includes sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other implementations, the HWD 150 includes more, fewer, or different components than shown in FIG. 1.

In some implementations, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some implementations, the eye trackers 160 include electronic components or a combination of electronic components and software components that determine a gaze direction of the user of the HWD 150. In some implementations, the HWD 150, the console 110 or a combination of them may incorporate the gaze direction of the user of the HWD 150 to generate image data for artificial reality. In some implementations, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some implementations, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some implementations, a user of the HWD 150 can configure the HWD 150 (e.g., via user settings) to enable or disable the eye trackers 160. In some implementations, a user of the HWD 150 is prompted to enable or disable the eye trackers 160.

In some implementations, the hand tracker 162 includes an electronic component or a combination of an electronic component and a software component that tracks a hand of the user. In some implementations, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some implementations, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some implementations, the image renderer 170 includes an electronic component or a combination of an electronic component and a software component that generates one or more images for display, for example, according to a change in view of the space of the artificial reality. In some implementations, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some implementations, the image data from the console 110 may be encoded, and the image renderer 170 may decode the image data to render the image. In some implementations, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some implementations, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some implementations, the electronic display 175 is an electronic component that displays an image. The electronic display 175 may, for example, be a liquid crystal display or an organic light emitting diode display. The electronic display 175 may be a transparent display that allows the user to see through. In some implementations, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some implementations, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some implementations, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some implementations, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other implementations, the console 110 includes more, fewer, or different components than shown in FIG. 1. In some implementations, the console 110 is integrated as part of the HWD 150.

In some implementations, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

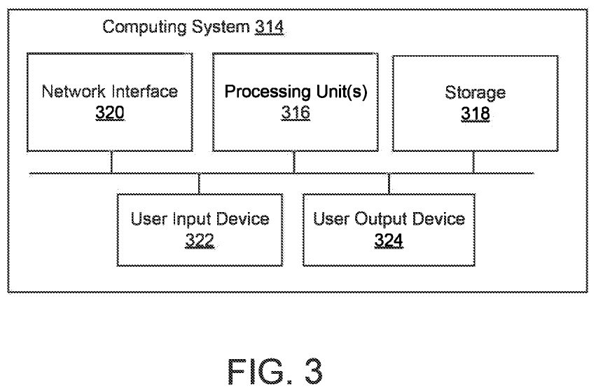

The content provider 130 can include or correspond to a component that generates content to be rendered according to the location and/or orientation of the HWD 150. In some implementations, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some implementations, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some implementations, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

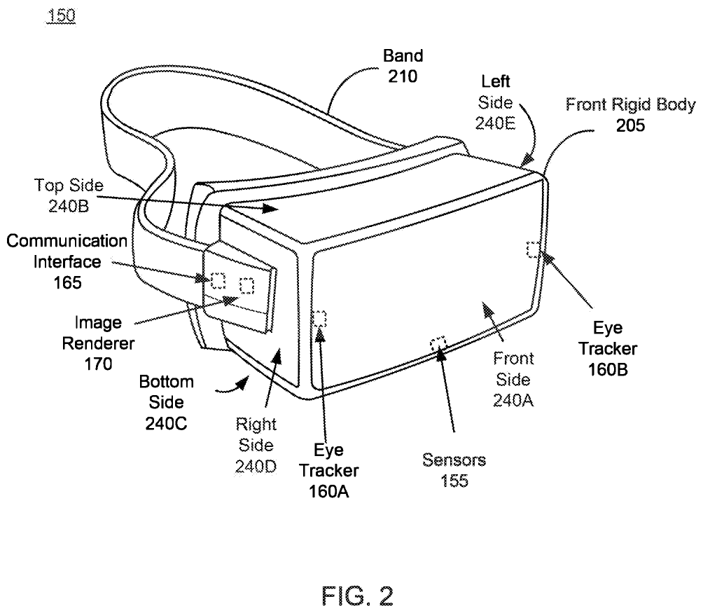

FIG. 2 is a diagram of a HWD 150, in accordance with an example implementation. In some implementations, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the implementation shown by FIG. 2, the communication interface 165, the image renderer 170, and the sensors 155 are located within the front rigid body 205, and may not be visible to the user. In other implementations, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of a representative computing system 314 usable to implement the present disclosure. In some implementations, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some implementations, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

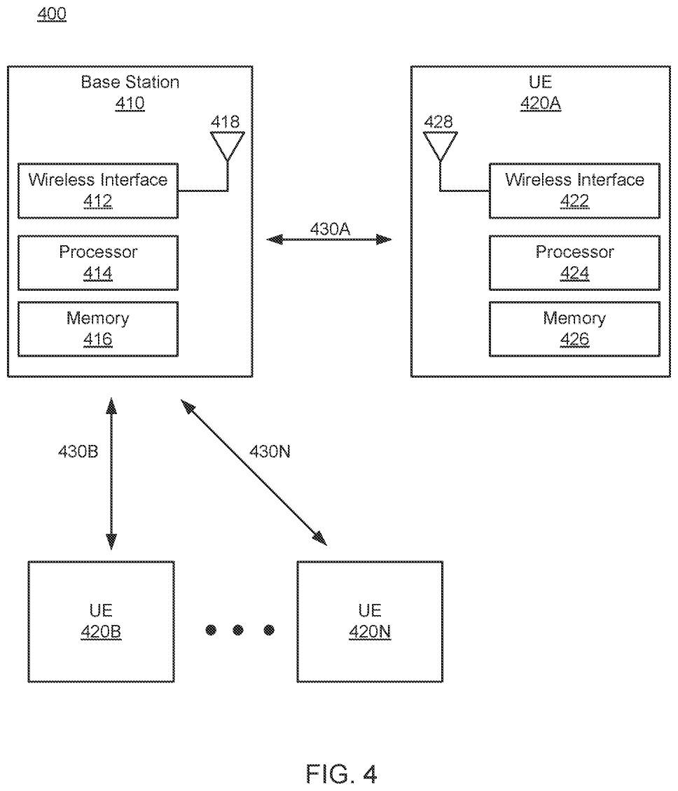

FIG. 4 illustrates an example wireless communication system 400. The wireless communication system 400 may include a base station 410 (also referred to as “a wireless communication node 410” or “a station 410”) and one or more user equipment (UEs) 420 (also referred to as “wireless communication devices 420” or “terminal devices 420”). The UEs 420 may be or include any device or component described above with reference to FIG. 1-FIG. 3, such as the console 110, head wearable display 150, or the like. The base station 410 and UEs 420 may include components, elements, and/or hardware similar to those described above with reference to FIG. 1-FIG. 3. The base station 410 and the UEs 420 may communicate through wireless commination links 430A, 430B, 430C. The wireless communication link 430 may be a cellular communication link conforming to 3G, 4G, 5G or other cellular communication protocols or a Wi-Fi communication protocol. In one example, the wireless communication link 430 supports, employs or is based on an orthogonal frequency division multiple access (OFDMA). In one aspect, the UEs 420 are located within a geographical boundary with respect to the base station 410, and may communicate with or through the base station 410. In some implementations, the wireless communication system 400 includes more, fewer, or different components than shown in FIG. 4. For example, the wireless communication system 400 may include one or more additional base stations 410 than shown in FIG. 4.

In some implementations, the UE 420 may be a user device such as a mobile phone, a smart phone, a personal digital assistant (PDA), tablet, laptop computer, wearable computing device, etc. Each UE 420 may communicate with the base station 410 through a corresponding communication link 430. For example, the UE 420 may transmit data to a base station 410 through a wireless communication link 430, and receive data from the base station 410 through the wireless communication link 430. Example data may include audio data, image data, text, etc. Communication or transmission of data by the UE 420 to the base station 410 may be referred to as an uplink communication. Communication or reception of data by the UE 420 from the base station 410 may be referred to as a downlink communication. In some implementations, the UE 420A includes a wireless interface 422, a processor 424, a memory device 426, and one or more antennas 428. These components may be embodied as hardware, software, firmware, or a combination thereof. In some implementations, the UE 420A includes more, fewer, or different components than shown in FIG. 4. For example, the UE 420 may include an electronic display and/or an input device. For example, the UE 420 may include additional antennas 428 and wireless interfaces 422 than shown in FIG. 4.

The antenna 428 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 428 may be a dipole antenna, a patch antenna, a ring antenna, or any suitable antenna for wireless communication. In one aspect, a single antenna 428 is utilized for both transmitting the RF signal and receiving the RF signal. In one aspect, different antennas 428 are utilized for transmitting the RF signal and receiving the RF signal. In one aspect, multiple antennas 428 are utilized to support multiple-in, multiple-out (MIMO) communication.

The wireless interface 422 includes or is embodied as a transceiver for transmitting and receiving RF signals through a wireless medium. The wireless interface 422 may communicate with a wireless interface 412 of the base station 410 through a wireless communication link 430A. In one configuration, the wireless interface 422 is coupled to one or more antennas 428. In one aspect, the wireless interface 422 may receive the RF signal at the RF frequency received through antenna 428, and downconvert the RF signal to a baseband frequency (e.g., 0-1 GHz). The wireless interface 422 may provide the downconverted signal to the processor 424. In one aspect, the wireless interface 422 may receive a baseband signal for transmission at a baseband frequency from the processor 424, and upconvert the baseband signal to generate a RF signal. The wireless interface 422 may transmit the RF signal through the antenna 428.

The processor 424 is a component that processes data. The processor 424 may be embodied as field programmable gate array (FPGA), application specific integrated circuit (ASIC), a logic circuit, etc. The processor 424 may obtain instructions from the memory device 426, and executes the instructions. In one aspect, the processor 424 may receive downconverted data at the baseband frequency from the wireless interface 422, and decode or process the downconverted data. For example, the processor 424 may generate audio data or image data according to the downconverted data, and present an audio indicated by the audio data and/or an image indicated by the image data to a user of the UE 420A. In one aspect, the processor 424 may generate or obtain data for transmission at the baseband frequency, and encode or process the data. For example, the processor 424 may encode or process image data or audio data at the baseband frequency, and provide the encoded or processed data to the wireless interface 422 for transmission.

The memory device 426 is a component that stores data. The memory device 426 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 426 may be embodied as a non-transitory computer readable medium storing instructions executable by the processor 424 to perform various functions of the UE 420A disclosed herein. In some implementations, the memory device 426 and the processor 424 are integrated as a single component.

In some implementations, each of the UEs 420B . . . 420N includes similar components of the UE 420A to communicate with the base station 410. Thus, detailed description of duplicated portion thereof is omitted herein for the sake of brevity.

In some implementations, the base station 410 may be an evolved node B (eNB), a serving eNB, a target eNB, a femto station, or a pico station. The base station 410 may be communicatively coupled to another base station 410 or other communication devices through a wireless communication link and/or a wired communication link. The base station 410 may receive data (or a RF signal) in an uplink communication from a UE 420. Additionally or alternatively, the base station 410 may provide data to another UE 420, another base station, or another communication device. Hence, the base station 410 allows communication among UEs 420 associated with the base station 410, or other UEs associated with different base stations. In some implementations, the base station 410 includes a wireless interface 412, a processor 414, a memory device 416, and one or more antennas 418. These components may be embodied as hardware, software, firmware, or a combination thereof. In some implementations, the base station 410 includes more, fewer, or different components than shown in FIG. 4. For example, the base station 410 may include an electronic display and/or an input device. For example, the base station 410 may include additional antennas 418 and wireless interfaces 412 than shown in FIG. 4.

The antenna 418 may be a component that receives a radio frequency (RF) signal and/or transmit a RF signal through a wireless medium. The antenna 418 may be a dipole antenna, a patch antenna, a ring antenna, or any suitable antenna for wireless communication. In one aspect, a single antenna 418 is utilized for both transmitting the RF signal and receiving the RF signal. In one aspect, different antennas 418 are utilized for transmitting the RF signal and receiving the RF signal. In one aspect, multiple antennas 418 are utilized to support multiple-in, multiple-out (MIMO) communication.

The wireless interface 412 includes or is embodied as a transceiver for transmitting and receiving RF signals through a wireless medium. The wireless interface 412 may communicate with a wireless interface 422 of the UE 420 through a wireless communication link 430. In one configuration, the wireless interface 412 is coupled to one or more antennas 418. In one aspect, the wireless interface 412 may receive the RF signal at the RF frequency received through antenna 418, and downconvert the RF signal to a baseband frequency (e.g., 0-1 GHz). The wireless interface 412 may provide the downconverted signal to the processor 424. In one aspect, the wireless interface 422 may receive a baseband signal for transmission at a baseband frequency from the processor 414, and upconvert the baseband signal to generate a RF signal. The wireless interface 412 may transmit the RF signal through the antenna 418.

The processor 414 is a component that processes data. The processor 414 may be embodied as FPGA, ASIC, a logic circuit, etc. The processor 414 may obtain instructions from the memory device 416, and executes the instructions. In one aspect, the processor 414 may receive downconverted data at the baseband frequency from the wireless interface 412, and decode or process the downconverted data. For example, the processor 414 may generate audio data or image data according to the downconverted data. In one aspect, the processor 414 may generate or obtain data for transmission at the baseband frequency, and encode or process the data. For example, the processor 414 may encode or process image data or audio data at the baseband frequency, and provide the encoded or processed data to the wireless interface 412 for transmission. In one aspect, the processor 414 may set, assign, schedule, or allocate communication resources for different UEs 420. For example, the processor 414 may set different modulation schemes, time slots, channels, frequency bands, etc. for UEs 420 to avoid interference. The processor 414 may generate data (or UL CGs) indicating configuration of communication resources, and provide the data (or UL CGs) to the wireless interface 412 for transmission to the UEs 420.

The memory device 416 is a component that stores data. The memory device 416 may be embodied as RAM, flash memory, ROM, EPROM, EEPROM, registers, a hard disk, a removable disk, a CD-ROM, or any device capable for storing data. The memory device 416 may be embodied as a non-transitory computer readable medium storing instructions executable by the processor 414 to perform various functions of the base station 410 disclosed herein. In some implementations, the memory device 416 and the processor 414 are integrated as a single component.

In some implementations, communication between the base station 410 and the UE 420 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

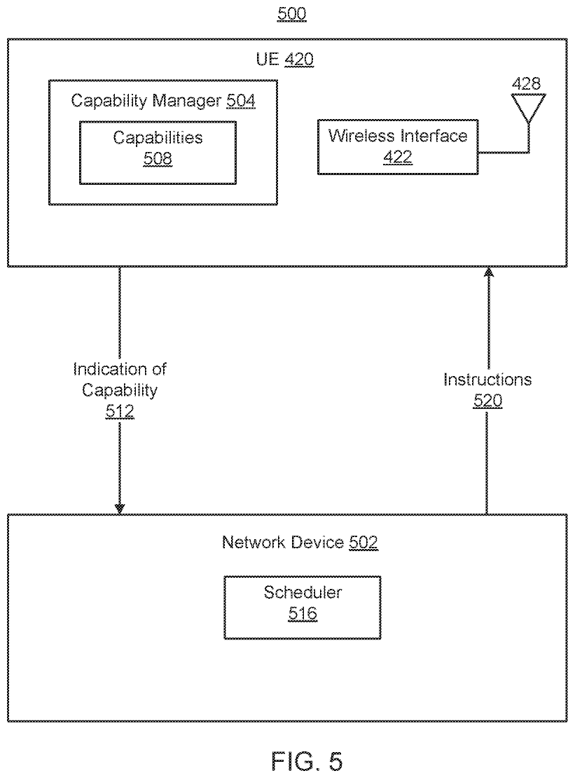

Referring now to FIG. 5, depicted is a block diagram of a system 500 that can implement operations including capability signaling for maximum sensitivity degradation performance, according to an example implementation of the present disclosure. The system 500 can include user equipment (UE) 420 communicably coupled to one or more network devices 502. The network devices 502 may be or include any networking device, component, or node along the network path between the UE 420 and network devices 502. For example, the network devices 502 can include one or more base stations 410, routers, switches, or any other network nodes.

The UE 420 may be configured to execute an application, which can have one or more functions hosted by an application provider (e.g., on one or more servers implemented by or coupled with the one or more network devices 502). In various implementations, the application can be an extended reality (XR) application (e.g., an augmented reality (AR), virtual reality (VR), mixed reality (MR), or other XR application). The application executing on the UE 420 can generate data for transmission to the network device 502 (and vice versa).

As depicted in FIG. 5, the UE 420 can include at least one capability manager 504. The capability manager 504 can include one or more functions, rules, heuristics, logic, data structures, machine learning models, computer-executable code, algorithms, or various combinations thereof to perform operations such as signaling capabilit(ies) of the UE 420 with respect to reception operation of the UE 420.

The capability manager 504 can identify one or more capabilities 508 of the UE 420 according to at least one characteristic of the UE 420. The capability 508 can represent an ability of at least one of the UE 420 or the wireless interface 422 to adjust a maximum sensitivity degradation (MSD) level of the at least one of the UE 420 or the wireless interface 422. For example, the UE 420 can have a criteria for reception of wireless signals by the wireless interface 422. The criteria can include a reference sensitivity (REF SENS). The reference sensitivity can be a minimum signal to noise ratio (SNR) (e.g., in dBm) of the receiver of the wireless interface 422 at which the wireless interface 422 achieves a target metric (e.g., throughput, block error rate) with respect to a signal received by the wireless interface 422 (e.g., at least 95% throughout; a block error rate corresponding the target throughput at the specified REF SENS level corresponding to one or more operating bands for the signal being communicated). The reference sensitivity level can be a number of resource block (RB) size in a bandwidth of a supporting channel based on transmission leakage in the receiver path in (e.g., relative to) thermal noise level where the UE 420 is expected to meet the target metric. The target metric can relate to a signal to interference and noise ratio (SNIR) of the reception by the UE 420.

In some instances, interference, including self-interference, can affect the ability of the UE 420 to achieve the reference sensitivity. The criteria applicable to the UE 420 can be adjusted, such as to have exceptions with respect to a downlink slot or receiver band, to allow the sensitivity of the wireless interface 422 to be degraded (e.g., subject to lesser criteria, such as to be allowed to operate with greater input power in the receive path of the wireless interface 422) when subject to interference. For example, operating the UE 420 in one or more modes that lead to factors such as harmonics, harmonic mixing, cross band isolation between proximate frequenc(ies) of a transmitter of the wireless interface 422 and a receiver of the wireless interface 422, or dual uplink transmission can make the UE 420 susceptible to self-interference, for which the UE 420 can have exceptions to allow modification to the criteria (e.g., in LTE/NR carrier aggregation (CA)/dual connectivity (DC) operation).

For example, the UE 420 can have an offset from the reference sensitivity (e.g., responsive to being subject to interference) represented by the capabilities 508. The offset can be a maximum sensitivity degradation (MSD) level. The MSD level can indicate an amount (e.g., in dBm) that the interference power level used to meet the target criteria (e.g., sensitivity) can be increased relative to the reference sensitivity, such as to allow the UE 420 to manage or account for greater interference power in order to meet target metrics such as target throughput or block error rate. For example, the MSD level can represent an exception from specified REF SENS requirements according to the operating bands for reception.

As an example, the reference sensitivity can be −97 dBm/CBW (channel bandwidth) in Band X, and the MSD level can be 10 dBm for CA/DC with Band X and Band Y due to the various factors as above-mentioned sources of interference. In such an example, the UE 420 can satisfy the criteria using a sensitivity (e.g., relaxed reference sensitivity) of −87 dBm/CBW.

As noted above, the reference sensitivity and/or MSD levels may be set based on operation of relatively low performance devices (e.g., RF architecture, receive chain, RF parameters of relatively low performance devices), which may have relatively low ability to modify operation in a manner that allows for improved sensitivity and/or MSD levels. To allow for more precise or otherwise more targeted use of MSD levels or other operations to account for interference, the UE 420 can communicate the capability 508, which can indicate the ability of the UE 420 to perform operations for and/or characteristics of components of the UE 420 for improving RF performance. The UE 420 can identify and/or determine the capability 508 according to testing of the UE 420, such as testing of the UE 420 that indicates actual performance (e.g., actual sensitivity) under various conditions. In some implementations, the UE 420 generates the capability 508, according to the one or more characteristics of the UE 420, to indicate a level of expected or actual performance (e.g., sensitivity) that the UE 420 is capable of relative to the MSD level specified for the UE 420; for example, for a given interference condition, a specification for the UE 420 may indicate an MSD level of 10 dB (e.g., 10 dB increase relative to the reference sensitivity), yet the UE 420 can have one or more characteristics to achieve the target metric (e.g., throughput and/or block error rate) with an MSD level of 4 dB, and as such the capability manager 504 can determine the capability 508 to indicate the MSD level of 4 dB to the network device 502 to allow for improvement of system capacity (e.g., enabling the network device 502 to generate signals for reception by the UE 420 that have greater information per block, having a higher MCS index, having a greater RB size, etc., compared to the specified MSD level of 10 dB). This can allow the network device 502 to provide communication instructions to the UE 420 and/or communicate with the UE 420 in a manner that takes advantage of the actual 4 dB MSD level as compared to the reference sensitivity, rather than operating by the specified MSD of the UE 420. For example, based on the UE 420 having an actual MSD of 4 dB, the UE 420 can report the lower MSD capability to the network device 502 (in contrast, if the actual MSD of the UE 420 is not lower than the specified MSD for a given operating band, the UE 420 may determine to not report a different MSD).

For example, with respect to characteristics of the UE 420 corresponding to the capability 508, the UE 420 can have an antenna isolation characteristic indicative of isolation between one or more antennas 428 of the UE 420, which can allow for reduced interference by isolating communications amongst antennas 428. The UE 420 can have a printed circuit board (PCB) isolation characteristic indicative of isolation of signals resulting from electrical activity of a PCB of the UE 420 relative to other components of the receive chain of the UE 420. The UE 420 can have an amplifier attenuation characteristic, such as a power amplifier (PA) attenuation characteristic, indicative of the ability of one or more amplifiers (e.g., power amplifier relative to low noise amplifier (LNA)) to have noise effects attenuated. The UE 420 can have characteristics relating to attenuation of harmonic effects, such as attenuation of harmonic filter. The UE 420 can have a cross band isolation characteristic indicative of the ability of the UE 420 (e.g., of the receive chain) to isolate signals across different communication bands (e.g., different frequency ranges) to be used for reception and/or transmission. The UE 420 can have a multiple communication (e.g., dual uplink) characteristic indicative of the ability of the UE 420 to isolate or attenuate signals being communicated simultaneously. The UE 420 can select the one or more characteristics to use to determine the capability 508 according to one or more sources of interference (e.g., harmonics, cross-band interference, PCB interference, etc.).

The UE 420 can communicate the capability 508 to indicate the ability of the UE 420 with respect to any one or more such characteristics (e.g., as in the example above, to have a 10 dBm MSD level in relation to harmonic/cross band isolation/dual uplink transmission. In some implementations, the UE 420 can generate the capability 508 according to a data structure, such as a table or bitmap, that can represent the capability 508 using relatively little data. Table 1 provides an example of how the UE 420 can represent the capability 508 in multiples or other metrics based on a threshold Th; the threshold Th can be, for example, 3 dB. The capability manager 504 can determine the capability 508.

TABLE 1
Example of Capability Signaling Table

| | Maximum Allowed Actual | |
|---|---|---|
| Bit Map | MSD Level (Thresholds) | Lower MSD Capability Class |
| 000 | 1Th | I |
| 001 | 2Th | II |
| 010 | 3Th | III |
| 100 | 4Th | IV |
| 101 | 5Th | V |
| 110 | 6Th | VI |
| 111 | >6Th | VII |

For example, the capability manager 504 can retrieve the value from a table (e.g., from the first column or third column) such as Table 1 according to the MSD level verified by testing for the UE 420, and generate an indication 512 of the capability 508 to represent the retrieved value.

The UE 420 can transmit a signal that includes the indication 512 to the network device 502. This can allow the network device 502 to perform various operations to more effectively facilitate communications to/from the UE 420. For example and without limitation, the network device 502 and/or UE 420 can use the indication 512 to meet and/or guarantee high-throughput performance given the same channel state information (e.g., maintain parameters of communication with the UE 420 that might otherwise be degraded under interference conditions); to select and/or modify a communication coding/encoding scheme according to the indication 512; to allow higher output power by the UE 420 for transmission according to the indication 512 (e.g., due to better reduction of interference, such as between reception and transmission channels, the UE 420 can provide more power to the wireless interface 428 for transmission); or various combinations thereof. The network device 502 can generate, according to the capability 508 indicated by the indication 512, one or more instructions 520 to facilitate various such operations by the UE 420. The network device 502 can generate the instructions 520 to indicate one or more parameters of operation of the UE 420, such as to indicate power, scheduling, channel usage, frequency usage, bandwidth, or various combinations thereof for how the UE 420 performs transmission and/or reception operations.

In some implementations, the network device 502 can select a mode of communication for data to be received by the UE 420 according to the indication 512 (e.g., according to the capability 508 represented by the indication 512). For example, where the capability 508 indicates the ability for the UE 420 to have higher reception performance than a baseline (e.g., than a baseline or specification-derived MSD level of exception from the reference sensitivity), the network device 502 can select a mode of communication having a coding scheme expected to have a greater amount of information per time and/or data packet. For example, the network device 502 can select a modulation coding scheme (MCS) having an MCS index according to the capability 508, such as to modulate and/or encode communications to be received by the UE 420 with a higher MCS index responsive to the capability 508 indicating that the UE 420 can perform more effectively than the baseline. The network device 502 can control at least one of a modulation type, coding rate, number of streams, channel width, or guard interval according to the capability 508 and/or the selected MCS index. The network device 502 can increase an RB size of a signal communicated to the UE 420 responsive to the capability 508 indicating that the MSD level of the UE 420 is lower (e.g., higher performance, such as less MSD compared with specification MSD) than the specification MSD.

The network device 502 can use any of various communication processes to provide the one or more instructions 520 to the UE 420, according to which the UE 420 can operate in relation to the capability 508. For example, the network device 502 can use a layer such as the RRC layer to provide RRC parameters representing the one or more instructions 520. This can include, for example, the network device 502 generating the instructions 520 to include RRCSteup and/or RRCReconfiguration instructions. The network device 502 can generate the instructions 520 to provide parameters for at least one of physical uplink shared channel (PUSCH) operations, physical downlink control channel (PDCCH) operations, or downlink control information (DCI) operations, such as to provide scheduling instructions for how the UE 420 performs reception and/or transmission operations.

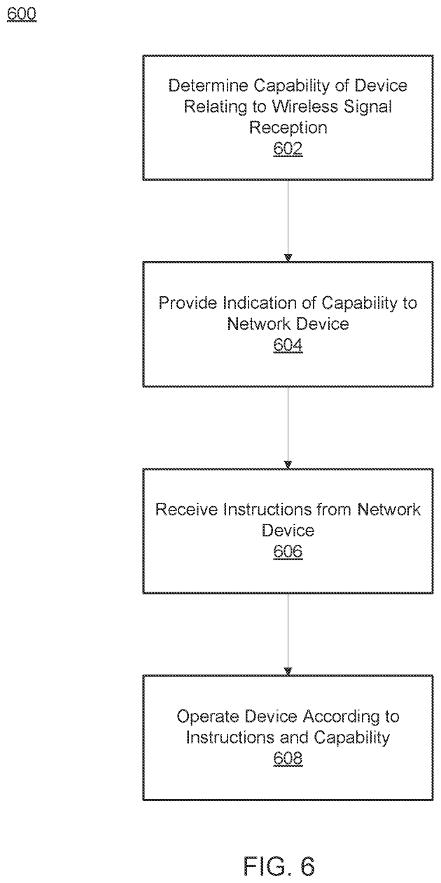

FIG. 6 shows a block diagram of a representative method 600 for capability signaling for maximum sensitivity degradation performance. In some implementations, the method 600 can be implemented by a device, such as a UE, configured to communicate with a second device, such as a base station, using a wireless connection. In brief overview, the method can include determining 602 a capability of the device relating to wireless signal reception by the device, such as a capability determined according to an aggressor and victim frequency gap, RB configuration, and/or whether intermodulation (IMD)/harmonic issues are expected or not. The method can include providing 604 an indication of the capability to the network device. The method can include receiving 606 one or more instructions from the network device relating to the capability. The method can include operating 608 the device according to the instructions and the capability. In some implementations, the method 600 can be performed by the wearable device 110 or the wearable device 150. In some implementations, the method 600 can be performed by other entities. In some implementations, one or more operations of the method 600 can be performed responsive to detection of an interference condition. In some implementations, the method 600 includes more, fewer, or different steps than shown in FIG. 6.

Referring to FIG. 6 in further detail, one or more processors of the device can determine 602 a capability of the device. The capability can be a capability of the device to control a parameter related to receiving a signal via a wireless communications interface of the device. For example, the capability can represent one or more characteristics such as at least one of an isolation or attenuation characteristic of one or more components of the device, such as of a receive chain and/or RF architecture of the device, by which the device can control (e.g., reduce, mitigate) interference or self-interference associated with reception and/or transmission by the wireless communications interface.

The parameter can be, for example, at least one of a sensitivity, a signal to noise ratio, an MSD level, a throughput of reception, or a bit error rate of reception, of the wireless communications interface. The characteristic can include or correspond to features of the device (e.g., as implemented by the receive chain and/or RF architecture) such as antenna isolation, PCB isolation, amplifier attenuation, or harmonic filter operation or attenuation.

The device can determine the capability according to the one or more characteristics, such as to identify the capability as a value representative of testing and/or verification of operation of the device to achieve the one or more characteristics. For example, the device can retrieve an indication of the capability, such as an indication of the capability that quantifies and/or or classifies how the device can use the one or more characteristics to mitigate or reduce interference (e.g., reduce MSD levels or otherwise have better sensitivity than a baseline). In some implementations, the device can retrieve the indication of the capability from a data structure, such as a table or bitmap, that maps a value representing the capability to the capability.

The one or more processors of the device can provide 604 the indication to the network device. This can allow the network device to at least one of (1) control operation of communications to the device or (2) provide instructions to the device according to the capability represented by the indication. For example, the network device can generate instructions, such as instructions of PUSCH, PDCCH, and/or DCI communications to the device. For example, the network device can select a modulation scheme, such as to select an MCI index, according to the capability (e.g., according to an expected performance of the device responsive to implementing the capability, such as to allow the network device to encode a greater amount of information since the device will be able to maintain or exceed the bit error rate or other metric while receiving data encoded with the greater amount of information). The network device can the generate the instructions to indicate one or more parameters of operation of the device, such as to indicate power, scheduling, channel usage, frequency usage, bandwidth, or various combinations thereof for how the device performs transmission and/or reception operations.

The one or more processors can receive 606 the instructions from the network device. The one or more processors can receive the instructions via any one or more communication pathways from the network device, such as from a control portion of a signal provided by the network device.

The one or more processors can operate 608 the device according to the instructions and the capability of the device. For example, where the instructions indicate the same parameters as prior to the capability being provided to the network device, the device can continue to operate in accordance with the same parameters, which can be expected to maintain or improve performance, such as to allow for greater throughput. Where the instructions indicate modified parameters, such as modifications to power, scheduling, channel usage, frequency usage, bandwidth, or various combinations thereof, the device can operate in accordance with the modified parameters, and can do so while continuing to meet criteria such as reference sensitivity criteria.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 316 can provide various functionality for the computing system 314, including any of the functionality described herein as being performed by a server or client, or other functionality associated with message management services.

It will be appreciated that the computing system 314 is illustrative and that variations and modifications are possible. Computer systems used in connection with the present disclosure can have other capabilities not specifically described here. Further, while the computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
a wireless communications interface; and
one or more processors to:
identify a capability of the device to control a parameter related to receiving a signal via the wireless communications interface, the capability representative of an improvement of reception by the device;
provide, to a network device using the wireless communications interface, a signal indicating the capability of the device; and
control operation of the wireless communications interface responsive to instructions received from the network device and related to the capability.

2. The device of claim 1, wherein the parameter corresponds to at least one of a receiver reference sensitivity of the wireless communications interface or an improved sensitivity degradation level of the wireless communications interface.

3. The device of claim 1, wherein the capability of the device relates to controlling a signal to interference and noise ratio of signals received by the wireless communications interface.

4. The device of claim 1, wherein the one or more processors are to apply an enhancement to a sensitivity of the wireless communications interface responsive to the instructions.

5. The device of claim 1, wherein the one or more processors are to monitor a sensitivity degradation related to a target signal received by the wireless communications interface, and provide the signal indicating the capability responsive to the monitoring.

6. The device of claim 1, wherein the one or more processors are to generate the signal indicating the capability using a bitmap.

7. The device of claim 1, wherein the one or more processors are to control operation of one or more antennas of the wireless communications interface responsive to the instructions.

8. A system, comprising:
a first device, comprising:
a wireless communications interface; and
one or more processors to:
identify a capability of the first device to control a parameter related to receiving a signal via the wireless communications interface, the capability representative of an improvement of reception by the device; and
transmit, using the wireless communications interface, a signal indicating the capability of the device; and
a second device configured to provide instructions to the first device to control operation of the first device according to the capability.

9. The system of claim 8, wherein the parameter corresponds to at least one of a receiver reference sensitivity of the wireless communications interface or an improved sensitivity degradation level of the wireless communications interface.

10. The system of claim 8, wherein the capability of the first device relates to controlling a signal to interference and noise ratio of signals received by the wireless communications interface.

11. The system of claim 8, wherein the one or more processors are to apply an enhancement to a sensitivity of the wireless communications interface responsive to receiving the instructions from the second device.

12. The system of claim 8, wherein the one or more processors are to monitor a sensitivity degradation related to a target signal received by the wireless communications interface, and provide the signal indicating the capability responsive to the monitoring.

13. The system of claim 8, wherein the one or more processors are to generate the signal indicating the capability using a bitmap.

14. The system of claim 8, wherein the one or more processors are to control operation of one or more antennas of the wireless communications interface according to the instructions.

15. The system of claim 8, wherein the first device is a user equipment, and the second device is a network base station.

16. A method, comprising:
identifying, by one or more processors of a device, a capability of the device to manage a parameter related to receiving a signal via a wireless communications interface of the device, the capability representative of an improvement of reception by the device;
providing, by the one or more processors using the wireless communications interface, to a network device, a signal indicating the capability of the device;
receiving, by the one or more processors using the wireless communications interface, subsequent to providing the signal, one or more instructions from the network device relating to the capability; and
operating, by the one or more processors, the device according to the instructions.

17. The method of claim 16, wherein the parameter corresponds to at least one of a receiver reference sensitivity of the wireless communications interface or an improved sensitivity degradation level of the wireless communications interface.

18. The method of claim 16, wherein the capability of the device relates to managing a signal to interference and noise ratio of signals received by the wireless communications interface.

19. The method of claim 16, further comprising applying an enhancement, by the one or more processors, to a sensitivity of the wireless communications interface responsive to the instructions.

20. The method of claim 16, further comprising:
monitoring, by the one or more processors, a sensitivity degradation related to a target signal received by the wireless communications interface; and
providing, by the one or more processors, the signal indicating the capability responsive to the monitoring.
